(19) United States
(12) Patent Application Publication
(10) Pub. No.: US 2006/0191128 A1
(43) Pub. Date: Aug. 31, 2006

(54) Magnetic head slider and method for manufacturing the same

(75) Inventors: Takuya Adachi, Niigata-ken (JP); Isao Nakabayashi, Niigata-ken (JP)

Correspondence Address: BRINKS HOFER GILSON & LIONE, P.O. BOX 10395, CHICAGO, IL, 60610, US

(73) Assignee: ALPS ELECTRIC CO., LTD.

(21) Appl. No.: 11/349,304

(22) Filed: Feb. 7, 2006

(30) Foreign Application Priority Data
Feb. 25, 2005 (JP) 2005-051125

(51) Int. Cl. G11B 5/127; G11B 5/60; H04R 31/00

(52) U.S. Cl. 29/603.12; 360/236.5

(57) ABSTRACT

A magnetic head includes a slider having a thin-film magnetic element disposed at a trailing end of a surface of the slider opposite a magnetic recording medium. The slider has side surfaces that may be substantially perpendicular to the surface opposite the recording medium and may extend in a direction in which the slider moves relative to the recording medium and inclined surfaces disposed between the surface opposite the recording medium and the side surfaces. The inclined surfaces may form obtuse angles with the surface opposite the recording medium and the side surfaces.

This application claims the benefit of priority to Japanese Patent Application No. 2005-051125, which was filed on Feb. 25, 2005, and which is incorporated herein by reference.

### TECHNICAL FIELD

The present invention relates to magnetic head sliders for mounting on, for example, hard disk drives, and particularly to a magnetic head including a slider having side surfaces formed in a predetermined shape and a method for manufacturing the slider.

### BACKGROUND

According to a conventional method for manufacturing magnetic head sliders for mounting on, for example, hard disk drives, many thin-film magnetic elements are formed on a substrate, which is then cut into chip bars (element rows). The cut surfaces of the chip bars are subjected to a predetermined polishing treatment. The chip bars have many recording and/or playback thin-film magnetic elements provided on the surfaces corresponding to the trailing end surfaces of sliders. The chip bars are processed to form magnetic head sliders having a predetermined rail pattern on a surface (ABS surface) opposite a magnetic recording medium. The thin-film magnetic elements are adjacent to the surfaces (ABS surfaces) of the sliders opposite a magnetic recording medium. The chip bars, which are formed of, for example, a ceramic substrate, are separated into the sliders.

A conventional method for separating a chip bar into individual sliders is described below with reference to FIGS. 9 and 10. Grooves 113 for defining sliders 111 are formed on a surface of a chip bar 110, as the base material for the sliders 111, using grindstones 131 for forming shallow grooves. The surface of the chip bar 110 corresponds to surfaces 112 of the sliders 111 opposite a recording medium. In FIG. 9, the surface of the chip bar 110 is separated into the surfaces 112 of the sliders 111 opposite a recording medium along the grooves 113.

The chip bar 110 is then cut along the centers of the grooves 113 using grindstones 132 for chip slicing which have a smaller width than the grooves 113 to form the individual sliders 111. The sliders 111 thus produced have step portions 113a left by the grooves 113 between the surfaces 112 opposite a recording medium and side surfaces 114 extending from the leading end to the trailing end of the sliders 111. The conventional chip slicing method undesirably causes burrs and grain dropping at edges 112a between the surfaces 112 opposite a recording medium and the step portions 113a and edges 114a between the step portions 113a and the side surfaces 114. The edges 112a and 114a, which remain as the final edges of the sliders 111, may hit and damage a magnetic disk if the sliders 111 are tilted.

In summary, according to conventional mechanical processes, a chip bar is finally cut using grindstones at right angles between step portions and side surfaces to separate individual sliders. The edges of the cut portions and the cut surfaces undesirably cause, for example, chipping, burrs, and grain dropping, which may damage a disk surface. In addition, chipping at the cut surfaces, for example, results in low yields in a checking step.

### BRIEF SUMMARY

A magnetic head including a slider that may not cause, for example, chipping or burrs at the edges of cut surfaces when sliders are separated is provided. Also provided is a method for manufacturing the magnetic head.

The magnetic head includes a slider having a thin-film magnetic element disposed at a trailing end of a surface of the slider opposite a magnetic recording medium. The slider has side surfaces that may be substantially perpendicular to the surface opposite the recording medium and may extend in a direction in which the slider moves relative to the recording medium and inclined surfaces disposed between the surface opposite the recording medium and the side surfaces. The inclined surfaces may form obtuse angles with the surface opposite the recording medium and the side surfaces.

Also provided is a method for manufacturing a magnetic head including a slider having a thin-film magnetic element disposed at a trailing end of a surface of the slider opposite a magnetic recording medium. This method includes forming thin-film magnetic elements at a trailing end of a substrate that is the base material for sliders so that the thin-film magnetic elements are aligned adjacent to a surface of the substrate opposite the recording medium. Next, tapered grooves may be formed along the centers of regions to be cut between slider areas, which each include one thin-film magnetic element. Then, the substrate may be cut along the centers of the tapered grooves to a width smaller than the maximum width of the tapered grooves, thereby forming sliders.

As described herein, inclined surfaces may be provided between the surfaces of the sliders opposite the recording medium and the side surfaces of the sliders. Accordingly, scratches, burrs, and grain dropping, for example, may not occur at the edges between the inclined surfaces and the surfaces opposite the recording medium and between the inclined surfaces and the side surfaces.

### BRIEF DESCRIPTION OF THE DRAWINGS

FIG. 1 is a perspective view showing a slider manufactured by a method for manufacturing a magnetic head according to one embodiment with a surface of the slider opposite a recording medium facing upward;

FIG. 2 is a diagram illustrating a step of the method for manufacturing a magnetic head according to one embodiment;

FIG. 3 is a diagram illustrating another step of the method for manufacturing a magnetic head according to one embodiment;

FIG. 4 is a diagram illustrating another step of the method for manufacturing a magnetic head according to one embodiment;

FIG. 5 is an electron micrograph showing the vicinity of a tapered groove edge near the trailing end surface of the slider manufactured by the method for manufacturing a magnetic head according to one embodiment;

FIG. 6 is an electron micrograph showing a chip-slice edge near the trailing end surface of the slider;

FIG. 7 is an electron micrograph showing the vicinity of the tapered groove edge near the center of the slider;

FIG. 8 is an electron micrograph showing the chip-slice edge near the center of the slider;

FIG. 9 is a diagram illustrating a step of a conventional method for manufacturing a magnetic head;

FIG. 10 is a diagram illustrating another step of the conventional method for manufacturing a magnetic head;

FIG. 11 is an electron micrograph showing an edge between a surface opposite a recording medium and a step portion of a slider manufactured by the conventional method for manufacturing a magnetic head near the trailing end surface of the slider;

FIG. 12 is an electron micrograph showing an edge between the step portion and a side surface of the slider manufactured by the conventional method for manufacturing a magnetic head near the trailing end surface of the slider;

FIG. 13 is an electron micrograph showing the edge between the surface opposite a recording medium and the step portion of the slider manufactured by the conventional method for manufacturing a magnetic head near the center of the slider; and

FIG. 14 is an electron micrograph showing the edge between the step portion and the side surface of the slider manufactured by the conventional method for manufacturing a magnetic head near the center of the slider.

### DETAILED DESCRIPTION

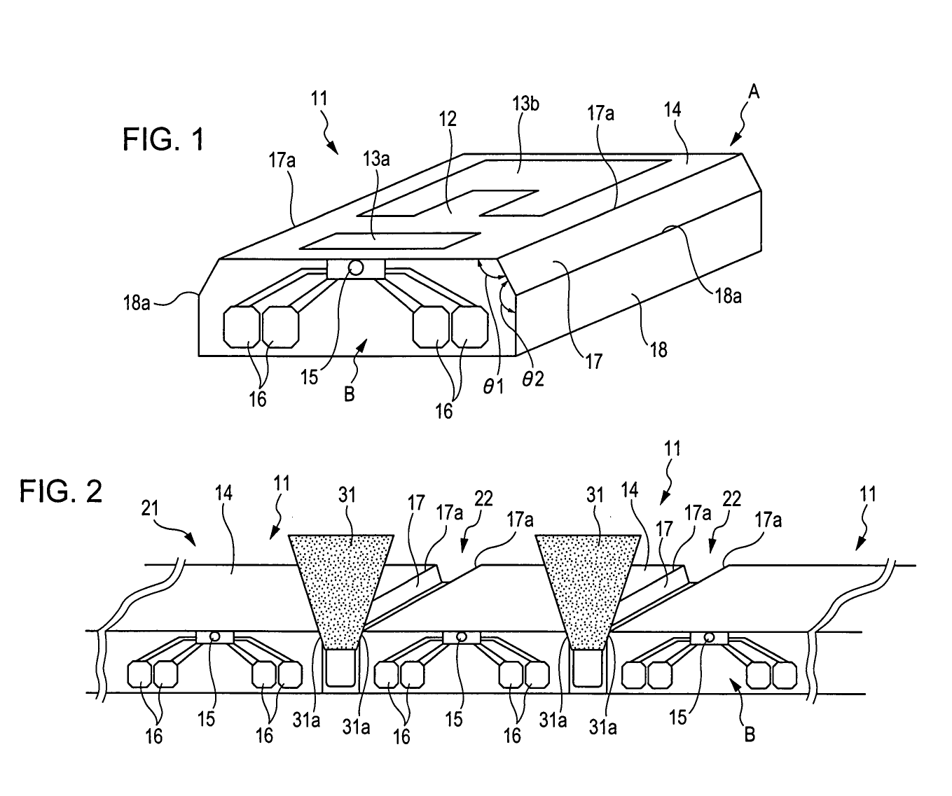

FIG. 1 is a perspective view showing a magnetic head for mounting on, for example, hard disk drives according to one embodiment with the surface of the head opposite a recording medium facing upward. In FIG. 1, a magnetic head slider 11 may be formed of silicon or a ceramic material such as alumina-titanium carbide. Rail portions 13a and 13bmay be formed on a surface 14 opposite a recording medium to define an air groove 12.

The outside of the rail portions 13a and 13b may be flush with the air groove 12 on the surface 14 opposite a recording medium. The two rail portions 13a and 13b may be formed in the present invention, although the number and shapes of the rail portions 13a and 13b is not limited to those shown in FIG. 1.

A thin-film magnetic element 15 and four electrodes 16 may be provided on a trailing end surface (trailing end) B of the slider 11. The thin-film magnetic element 15 may be adjacent to the surface 14 opposite a recording medium, and the electrodes 16 may be disposed near the back surface, opposite the surface 14. The thin-film magnetic element 15 may be covered with a protective film (not shown) formed of a ceramic material such as alumina (Al₂O₃)

The thin-film magnetic element 15 may be composed of laminated layers including, for example, a magnetic layer formed of permalloy (NiFe-based alloy) and an insulating layer formed of alumina. The thin-film magnetic element 15 may include a magnetic sensing portion for playing back magnetic signals recorded on a magnetic disk and/or a magnetic recording portion for recording magnetic signals on a magnetic disk. The magnetic sensing portion may be, for example, a giant magnetoresistive (GMR) head including a GMR element. The magnetic recording portion may be, for example, an inductive head including a coil and a core formed by patterning. The magnetic sensing portion and the magnetic recording portion are connected to the corresponding electrodes 16.

The shape of the side surfaces of the slider 11 is described below. In FIG. 1, inclined surfaces 17 may be formed between the surface 14 opposite a recording medium and the side surfaces 18 extending from the leading end surface A to the trailing end surface B (in a direction in which the slider 11 moves relative to a recording medium). The surface 14 opposite a recording medium may form right angles with the side surfaces 18. The inclined surfaces 17 may form obtuse angles with the surface 14 opposite a recording medium and the side surfaces 18. The angles (interior angles) between the surface 14 opposite a recording medium and the inclined surfaces 17, θ₁, may fall within the range of 90°<θ₁<180°.

Because the surface 14 opposite a recording medium may be substantially perpendicular to the side surfaces 18, the angles (interior angles) between the inclined surfaces 17 and the side surfaces 18, θ₂, may be equal to 270°−θ₁. The angles θ₁ and θ₂ may be the same, namely θ₁=θ₂=135°, or may be adjusted to 90°<θ₂<θ₁ or θ₁<θ₂<180°, where the angles θ₁ and θ₂ are obtuse angles of more than 90°.

Next, a method for manufacturing the slider 11 according to one embodiment is described below with reference to FIGS. 2 to 4. In FIG. 2, many thin-film magnetic elements may be formed on a surface of a wafer of, for example, silicon or a ceramic material such as alumina-titanium carbide in the longitudinal and lateral directions, and the wafer may be cut along element rows to prepare chip bars 21 as the base materials for many sliders 11. Tapered grooves 22 having a tapered shape in cross-section (that is, their width decreases from the openings to the bottoms) may be formed using, for example, tapered grindstones 31 on the surface of each of the chip bars 21 opposite a recording medium along the centers of regions to be cut for separating the chip bar 21 into the sliders 11. The width of the tapered grooves 22 formed using the tapered grindstones 31 may decrease in the depth direction. The inclined surfaces of the tapered grooves 22 correspond to the inclined surfaces 17 (see FIG. 1 or 4) of the sliders 11. The tapered grindstones 31 have the shape of an isosceles trapezoid in cross-section in FIG. 2, though the shape of the tapered grindstones 31 is not limited to that shape; alternatively, the tapered grindstones 31 may have, for example, the shape of an isosceles triangle, a trapezoid with a semicircular end, or a trapezoid with rounded corners.

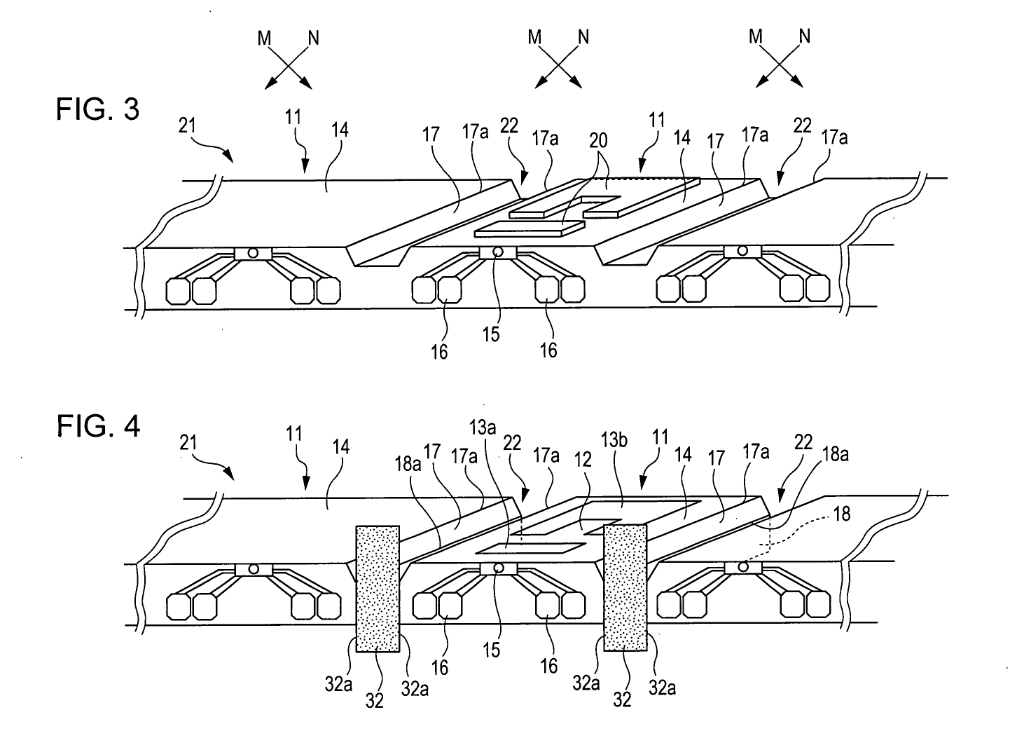

Referring to FIG. 3, resist layers 20 may be formed in slider areas between the tapered grooves 22 on the surface of the chip bar 21 in order to define the surfaces 14 of the sliders 11 opposite a recording medium and the rail portions 13a and 13b. The uncovered portions of the surface of the chip bar 21 may be etched by ion milling to define the rail portions 13a and 13b and the surfaces 14 of the sliders 11 opposite a recording medium. The resist layers 20 may then be removed to expose the rail portions 13a and 13b. As shown in FIG. 3, the surfaces 14 opposite a recording medium may be irradiated with neutral ions, such as Ar ions, in the M and N directions to round the edges of the surfaces 14 because the ion-milling step may be carried out with the chip bar 21 being rotated. In the ion-milling step, the boundaries between the inclined surfaces 17 in the tapered grooves 22 and the surfaces 14 opposite a recording medium may be simultaneously etched and rounded.

Referring to FIG. 4, the chip bar 21 may be cut along the centers of the tapered grooves 22 formed on the chip bar 21 to separate the individual sliders 11. The cutting may be done using, for example, rotating grindstones 32 for slicing which have a width smaller than the maximum width of the tapered grooves 22. Thus, the chip bar 21 may be cut along the centers of the tapered grooves 22 using the rotating grindstones 32 for slicing to form the side surfaces 18, which may extend from the inclined surfaces 17 in a direction substantially perpendicular to the surfaces 14 opposite a recording medium. The angles θ₁ and θ₂ may be obtuse angles.

In the method according to one embodiment of the present invention, the ends 31a of the side surfaces of the tapered grindstones 31 may form angles of less than 90° C. (acute angles) with the surface of the chip bar 21 in the formation of the tapered grooves 22 on the chip bar 21. Such cutting angles may reduce, for example, burrs and grain dropping at the tapered groove edges 17a between the surfaces 14 opposite a recording medium and the inclined surfaces 17. Also, the ends 32a of the side surfaces of the rotating grindstones 32 for slicing may form angles of less than 90° C. (acute angles) with the inclined surfaces 17 in the tapered grooves 22. Such cutting angles may reduce, for example, burrs and grain dropping at the chip-slice edges 18a between the inclined surfaces 17 and the side surfaces 18. Furthermore, the ion-milling step before the cutting step may remove, for example, burrs and scratches at the tapered groove edges 17a and the inclined surfaces 17 to provide smooth surfaces.

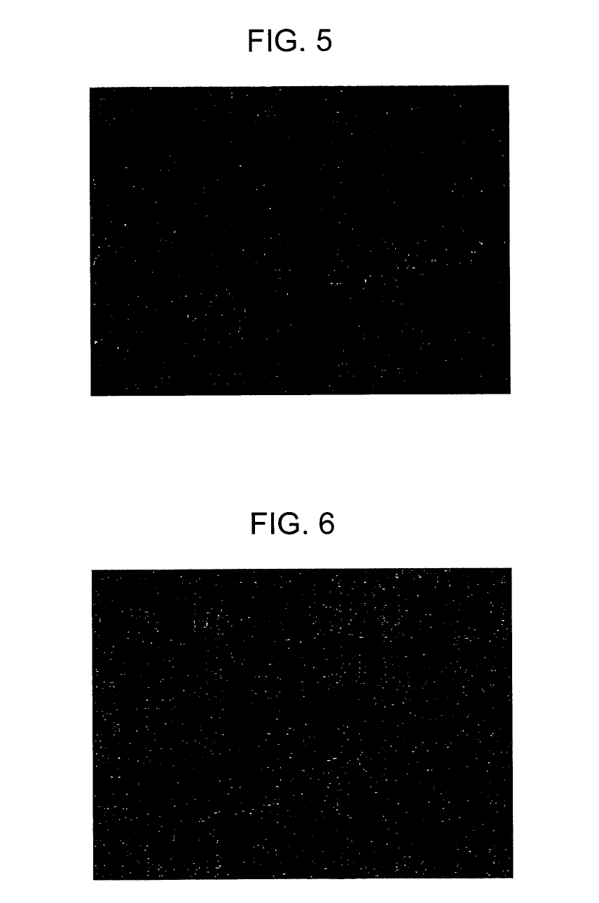

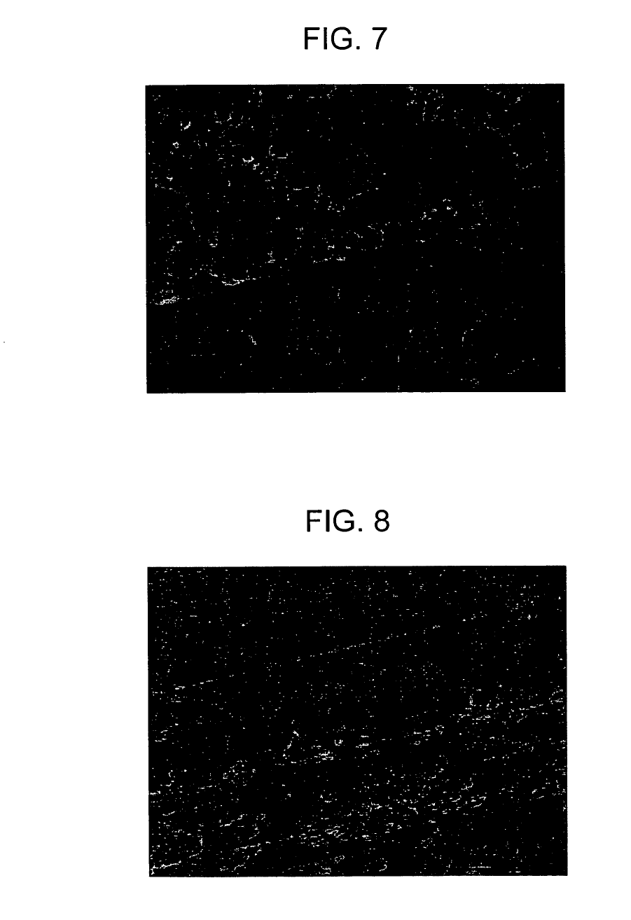

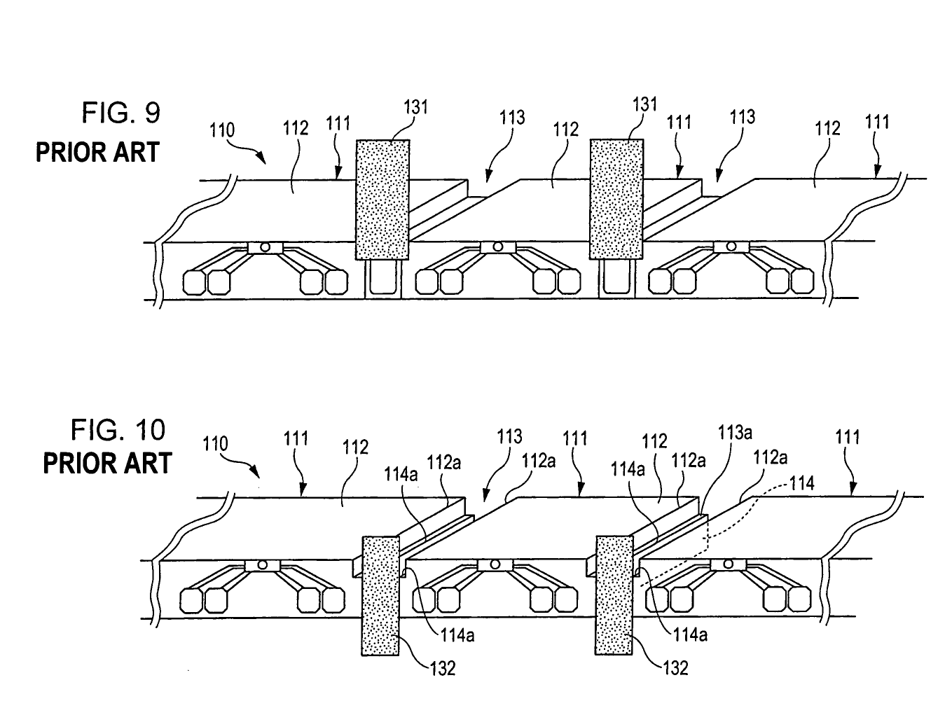

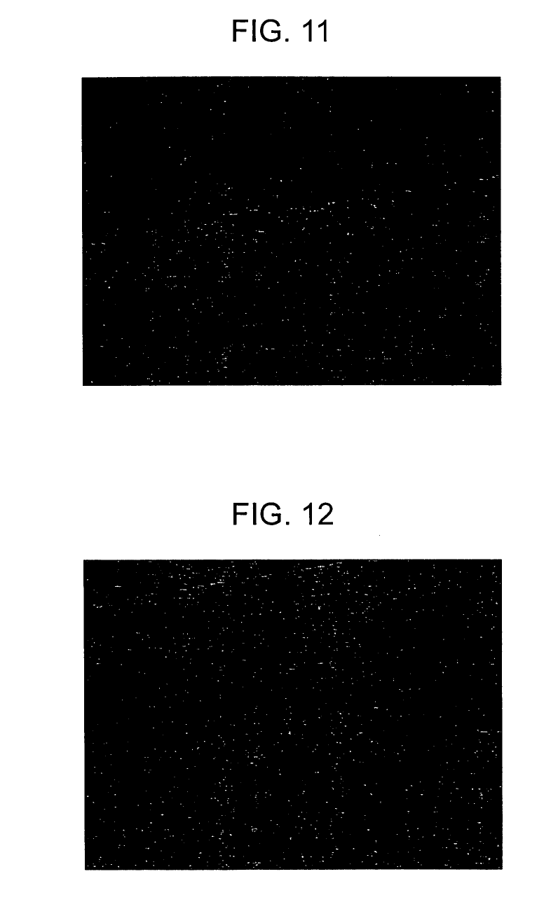

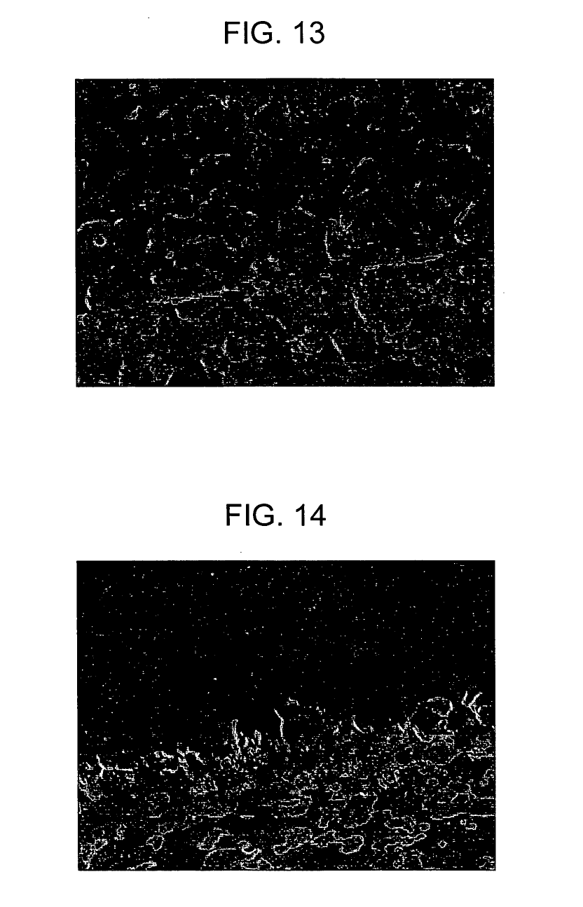

FIG. 5 is an electron micrograph showing the surface conditions of the tapered groove edges 17a and the inclined surfaces 17 near the trailing end surface of the slider 11 manufactured by the method according to the embodiment of the present invention. FIG. 6 is an electron micrograph showing the surface conditions around the chip-slice edges 18a near the trailing end surface of the slider 11. FIG. 7 is an electron micrograph showing the surface conditions of the tapered groove edges 17a and the inclined surfaces 17 near the center of the slider 11. FIG. 8 is an electron micrograph showing the surface conditions around the chip-slice edges 18a near the center of the slider 11. FIGS. 11 to 14 are electron micrographs showing the respective portions of a slider manufactured by a conventional method which correspond to the portions shown in FIGS. 5 to 8. These micrographs show that the slider 11 manufactured by the method according to the embodiment of the present invention has fewer irregularities in surface grain alignment and less chipping, burrs, and grain dropping.

Tapered grooves 22 may be formed using the tapered grindstones 31 of the above embodiment. Alternatively, multiple inclined surfaces may also be formed by forming grooves in several steps using, for example, two or more types of tapered grindstones so that the angles between the surfaces of sliders opposite a recording medium and the inclined surfaces decrease stepwise.

What is claimed is:

1. A magnetic head comprising a slider having a thin-film magnetic element disposed at a trailing end of a surface of the slider opposite a magnetic recording medium, the slider comprising:
side surfaces that are substantially perpendicular to the surface opposite the recording medium and extend in a direction in which the slider moves relative to the recording medium; and
inclined surfaces disposed between the surface opposite the recording medium and the side surfaces.

2. The magnetic head according to claim 1, wherein the inclined surfaces form obtuse angles with the surface opposite the recording medium and the side surfaces.

3. The magnetic head according to claim 1, wherein the inclined surfaces of the slider each comprise at least two surfaces so that the angles between the surface opposite the recording medium and the inclined surfaces decrease stepwise.

4. A method for manufacturing a magnetic head including a slider having a thin-film magnetic element disposed at a trailing end of a surface of the slider opposite a magnetic recording medium, the method comprising the steps of:
forming thin-film magnetic elements at a trailing end of a substrate that is the base material for sliders so that the thin-film magnetic elements are aligned adjacent to a surface of the substrate opposite the recording medium;
forming tapered grooves along the centers of regions to be cut between slider areas including one thin-film magnetic element; and
cutting the substrate along the centers of the tapered grooves to a width smaller than the maximum width of the tapered grooves, thereby forming sliders.

5. The method for manufacturing the magnetic head according to claim 4, further comprising, between the step of forming the tapered grooves and the cutting step, patterning the surface of the substrate opposite the recording medium in the areas between the tapered grooves.

6. The method for manufacturing the magnetic head according to claim 5, wherein the patterning of the surface of the substrate comprises the steps of:
providing resist layers on the surface of the substrate opposite the recording medium in the areas between the tapered grooves; and
etching portions of the surface of the substrate which are not covered by the resist layers by ion milling, thereby patterning the surface opposite the recording medium.

7. The method for manufacturing the magnetic head according to claim 4, wherein a tapered grindstone is used in the step of forming the tapered grooves.

8. The method for manufacturing the magnetic head according to claim 7, wherein the tapered grindstone used in the step of forming the tapered grooves has a shape of an isosceles trapezoid or an isosceles triangle.

9. The method for manufacturing the magnetic head according to claim 7, wherein the tapered grindstone used in the step of forming the tapered grooves is a rotating grindstone.
